(19) United States
(12) Patent Application Publication
(10) Pub. No.: US 2011/0209670 A1
(43) Pub. Date: Sep. 1, 2011

(54) Pet entertainment device and system

(76) Inventors: Scott A. McElwain, Midland, TX (US); Denise L. McElwain, Midland, TX (US); Chace A. McElwain, Midland, TX (US)

(21) Appl. No.: 12/932,327

(22) Filed: Feb. 23, 2011

Related U.S. Application Data
(60) Provisional application No. 61/339,068, filed on Feb. 26, 2010.

(51) Int. Cl. A01K 15/02; A01K 29/00

(52) U.S. Cl. 119/707

(57) ABSTRACT

A pet entertainment device includes a base having means for securing the base to a support. A platform is attached to the base. A retractable device is attached to the platform and includes a resiliently mounted tether forcibly extendable and automatically retractable relative to the platform. A pet toy is attached to a terminal end of the tether adjacent to the platform. In this manner, the toy can be forcibly extended away from and automatically retracted toward the platform.

### CROSS REFERENCE TO RELATED APPLICATION

This is a utility application related to U.S. Provisional Patent Application No. 61/339,068 filed Feb. 26, 2010, which is incorporated herein by reference in its entirety.

### BACKGROUND

The present disclosure herein relates generally to pets and more particularly to a pet entertainment apparatus and system.

Over time, man has developed symbiotic relationships with animals, particularly dogs, for both survivorship and companionship. Whether companionship or survival was the goal of the relationship, man has used various means to train animals to understand basic commands, both verbal and non-verbal. In order for this training to be effective, man acquired certain basic understandings of animal behaviors so that the training could be tailored to achieve the desired outcome. This is especially true when training dogs.

One such animal behavior, is commonly referred to as “Chase and Engage” behavior, or more commonly, the “Fetch and Retrieve Response”. There are a number of reasons why an understanding of this behavior is important. One reason is to establish behavior which can be a building block for cooperation. One good way to teach a pet, such as a dog, cooperation, is through the use of toys, by creating interest in an object by the dog, causing the dog to run after it, retrieve it, and then relinquish it. In animal training parlance, this is sometimes referred to as the “Give, Take and Recall” chain of behavior. A second reason is to provide a natural outlet for pets, such as dogs, who commonly love to chase things, as most animals will do in the wild, as a result of their natural hunting instinct. In this way, man has been able to redirect predatory behavior through interactive play with their pets. A third, less obvious reason, is simply interactive play, which can be utilized for conditioning, exercise, or to burn off excess energy, through games such as “tug of war”.

Unfortunately, activities and traditional animal toys associated with interactive “Fetch and Retrieve” training, utilizing such items as stuffed animals, balls, sticks, rope, pull-toys, or chew toys, all require constant human interaction. Otherwise, the pet will quickly lose interest in the object, becoming bored with the object after a short time, and wander off in search of other, more stimulating activities.

Having recognized this behavior, disclosed herein is a device that provides a mechanical, interactive resistance device and system which causes an attached toy to retract, or provide a counter-resistance in response to playful tugging by the pet, thus further stimulating the pet's natural instinct to pull on the toy in a “tug-of-war” fashion, or alternatively, to chase the toy as a fleeing object, when pulled, then released. In this way, the pet can be entertained without constant human interaction. Surprisingly, it has been discovered that the disclosed device is particularly useful with young dogs, in that it has the added benefit of effectively tiring puppies to the point of exhaustion, resulting in longer sleep patterns that are better suited to a domesticated lifestyle.

### SUMMARY

One embodiment, accordingly, includes a pet toy apparatus and system having a base including means for securing the base to a support. A platform is attached to the base. A retractable device is attached to the platform and includes a resiliently mounted tether forcibly extendable and automatically retractable relative to the platform. A pet toy is attached to a terminal end of the tether adjacent to the platform. In this manner, the toy can be forcibly extended away from and automatically retracted toward the platform.

### BRIEF DESCRIPTION OF THE DRAWINGS

FIG. 1 is a perspective view illustrating an embodiment of a pet entertainment apparatus and system.

FIG. 2 is an underside view illustrating an embodiment of a platform used in the apparatus and system of FIG. 1.

FIGS. 3A-3C are views illustrating embodiments of temporary mounting bases with a screw type anchor.

FIG. 4A-4B are views illustrating an embodiment of a mounting base for fixed attachment to a solid surface.

FIG. 5 is a view illustrating an embodiment of a retractable cord device.

FIGS. 6A-6C are views illustrating an embodiment of a base attachable to a bottom edge of a door.

FIGS. 7A-7B are views illustrating an embodiment of an alternate platform attachable to the base of FIGS. 6A-6C.

FIG. 8 is a view illustrating an embodiment of an alternate base plate attachable to a wall, fence, or post, and also usable with the platform of FIGS. 7A-7B.

### DETAILED DESCRIPTION

For the purposes of the present disclosure, the terms and phrases as used herein are intended to have the following general, non-restrictive meanings:

Retractable cord device can mean a retracting or retractable device, which may include a housing, a recoil mechanism, a spool, a spring, and a cord, tether or line. The retracting device and its components, may include a housing which may be comprised of a substantially rigid material, for example, plastic, metal, ABS, or the like. The retractable cord mechanism may be a conventional recoil or retraction mechanism that includes a spool. The spool allows the cord to be wound about it at a first terminal end of the cord. The recoil mechanism with a spindle also allows the cord to be unwound when a second terminal end of the cord is pulled, by force, and then allows the line to be automatically rewound about it when the second end of the cord, having a pet toy attached thereto, is released.

It is also meant to be understood that a retractable cord mechanism may also mean one or more strands of an elastic material, such as a bungee cord, rubber bands, or similar materials, typically made from natural or synthetic materials such as rubber or latex, having excellent extensibility, resilience and tensile strength and including the ability to provide a broad range of tension forces by using variable sizes, materials, etc.

Suction device can mean any device providing a base and commonly using suction for attachment of various articles to a support surface without marring the support surface. The actual suction may be created mechanically with a diaphragm and lever action or with a vacuum generating device.

Ground stake can mean any form of stake or long nail commonly providing a base and associated with those used in the construction of temporary tent-like housing, to fix restraining ropes attached to tent and ridge poles, into the ground.

Ground screw can mean any cylindrical screw-thread device for providing a base and removably anchoring objects to the ground. The screw thread may include a taper in the diameter and depth, from the proximal portion to the distal tip. The screw thread may also be in the form of an extended coil, similar to a cork screw.

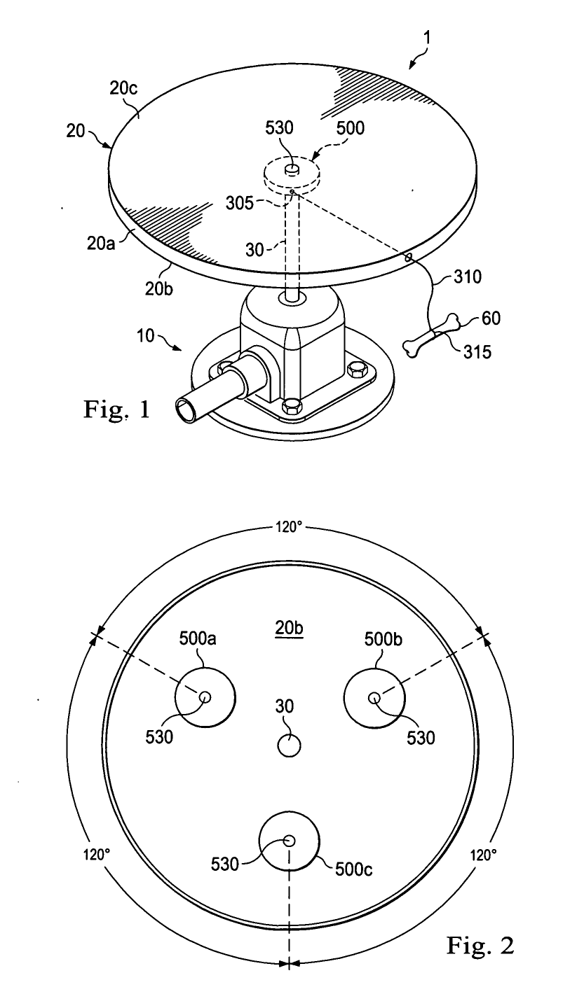

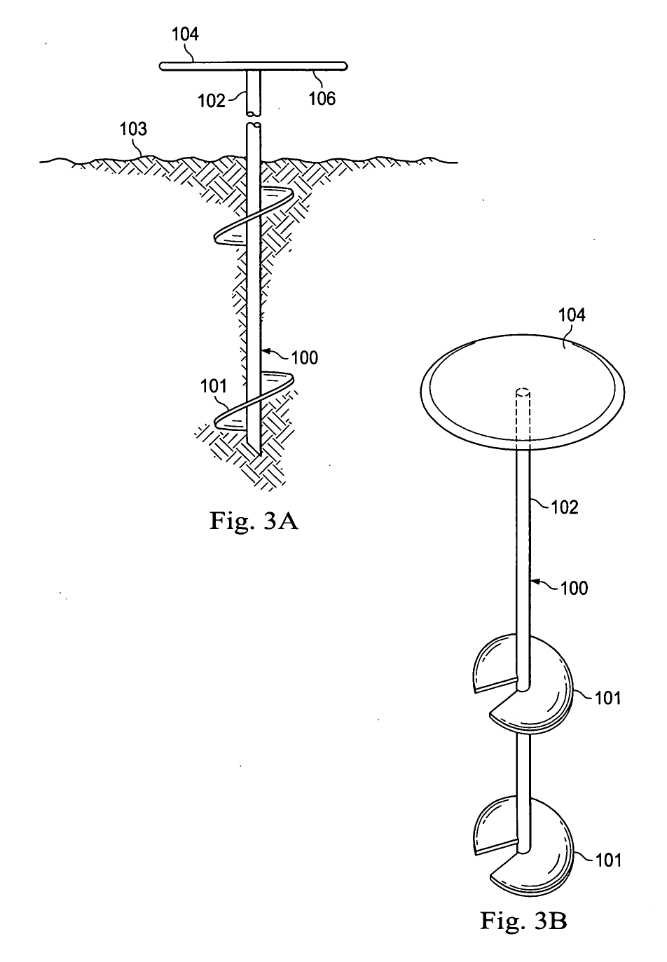

Referring to FIGS. 1 and 2 of the drawings, a preferred embodiment of an apparatus 1 is illustrated with a hand-pumped vacuum mounted base 10, having connected proximally to it, a disk shaped platform 20 with a rotatable central spindle 30. Attached to an underside 20b of platform 20, is at least one retractable cord device 500 illustrated also as 500A, 500B, 500C attached for rotation about an attachment point 530, and each including a cord 310, wherein a first end 305 of said cord 310 is attached to the attachment point 530 on the platform 20 and a second end 315 of said cord 310 can be extended beyond a periphery 20a of the platform 20, for example, through a guided opening 25 in the periphery 20a of said platform, and attached to a pet toy 60. A top portion 20c of the rotatable platform 20 is smooth, preferably with no sharp edges. The platform 20 can be colorized in order to disguise the components mounted thereunder, or clear, or may be decorated in a fashion that might further appeal to the pet.

The underside 20b of platform 20, in FIG. 2 illustrates one of many possible configurations for placement of multiple retractable cord devices, 500A, 500B, 500C, etc., potentially spaced at equal intervals on the underside 20b of the platform 20 around the central rotatable spindle 30, each attached to a separate attachment point 530. As illustrated in FIG. 1, an alternate placement configuration of a single retractable cord device 500 could be centrally located along the axis of the rotatable central spindle 30. And yet another alternate configuration could be multiple retractable cord devices 500A, 500B, 500C, etc., stacked vertically upon one another, and located along the axis of the rotatable central spindle 30, adjacent the underside 20b of the platform 20.

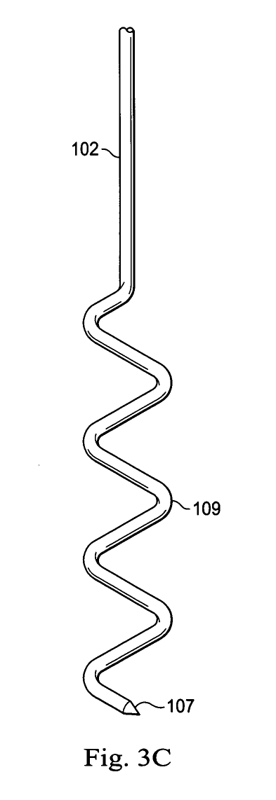

FIGS. 3A-3B illustrate alternative embodiments of temporary mounting bases that can be placed in a support surface such as the ground utilizing various screw mechanisms. The use of these temporary devices allows for easy relocation of an associated pet toy in an outdoor environment. FIG. 3A illustrates a side view of a threaded device 100, with an auger-type thread 101 on a post 102, threaded into and supported by the ground 103. A top surface 104 of the device is preferably flat and smooth, and can be any geometric planer shape, such as round, square, hexagonal, or triangular, and sized to appropriately accommodate the platform 20 as described above. FIG. 3B is a perspective view, illustrating auger-type threads 101 and flat, circular, top mounting surface 104.

FIG. 3C illustrates an alternative embodiment of the mounting post or base for a temporary mounting device, in the form of a corkscrew. The mounting post 102 is preferably a metal shaft, twisted into a corkscrew shape 109 for a distance of no less than one third of its entire length, having a distal point 107, to allow for easier penetration into the ground.

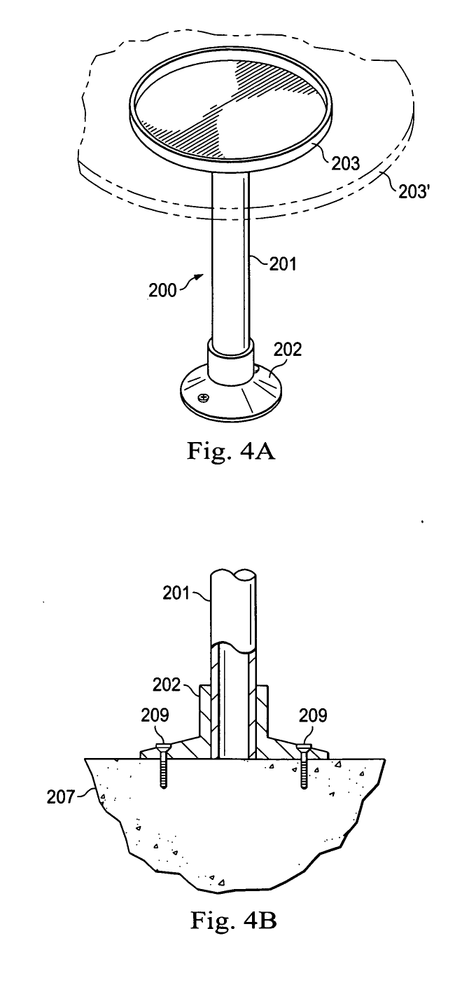

FIGS. 4A-4B illustrate alternative embodiments of a permanent mounting device that can be placed on a hard metal or wooden floor, concrete slab or other permanent ground surface utilizing various attachment means including screws, nails, flooring anchors, welds or other commonly understood attachment means. FIGS. 4A and 4B illustrate a perspective and side view of a permanent mounting device 200, with a mounting platform 203 that can be of variable size and shape 203, to attach a post 201 connecting the mounting platform 203 to a mounting base 202 for permanent attachment to a hard, permanent support surface 207, said mounting base 202 attached to said surface 207 with attachment means 209.

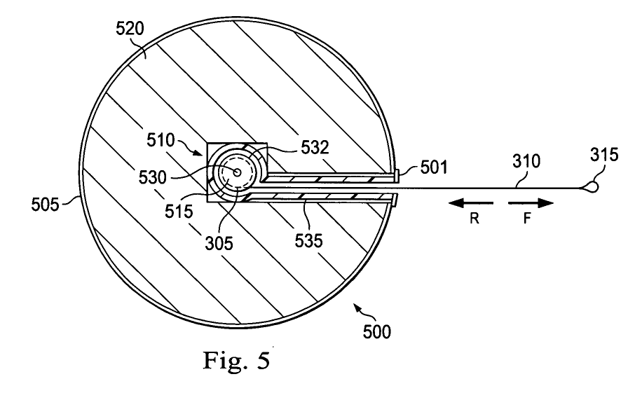

FIG. 5 illustrates one embodiment of a retractable cord device 500, shown in a cross-sectional view from a top view perspective. The device 500 can be encased in a housing 505, having an interior spring expansion space 520 to contain a retractable spring assembly 510, wherein is mounted a spring loaded spindle 532 with a coil spring 515 rotatably mounted about attachment point 530. Attached to the spindle is the first end 305 of cord 310, coiled about the spindle 532. The second end 315 of cord 310 extends from the spindle 532 through a guide tube 535 to an opening in the housing 505. The second cord end 315 of cord 310, may ultimately extend beyond the periphery 20a of the platform 20, see FIGS. 1 and 2. When the pet toy 60 (FIG. 1) attached to cord end 315 is pulled, by an applied force F, the retraction mechanism of retractable cord device 500 is engaged, providing a resistive pulling sensation R, to the pet to engage its natural fetch and retrieve instinct. The amount of resistance sensed by the pet can be variable, depending on the spring force built into the device which also automatically retracts the cord. It would be appreciated by one skilled in the art, that this device would essentially simulate a tug-of-war sensation for the pet. Ideally, it has been determined that the resistive force suitable for the retractable cord mechanism would be between one quarter and one and one half times the pets own body weight.

It is also the intent of this disclosure to allow for a retractable cord mechanism that provides for a variable resistive tension. Specifically, a variable resistive tensioning mechanism is defined as a mechanism that would provide increasing tension, from the perspective of the pet, when the toy is pulled further away from the base. As an example, the mechanism could provide a gradually increasing resistance between zero and three pounds of resistance when the toy, attached to the cord mechanism, is pulled up to six inches away from the platform. However, the resistive force could be provided to gradually increase up to 15 pounds when the toy is further pulled up to 12 inches away from the base. This perceived force would continue to increase, out to the full extension of the cord. This resistive load could theoretically be provided to increase to almost any reasonable value, suitable for the pet intended. This increasing resistive load need not be mathematically linear in its progression.

It should be appreciated by one skilled in the art that a retractable cord device may also simply mean one or more strands of an elastic material (not shown), such as a bungee cord, rubber bands, or similar materials, typically made from natural or synthetic materials such as for example, rubber or latex, having excellent extensibility, resilience and tensile strength. A retractable cord such as this would serve the same function as a mechanical assembly such as that described in FIG. 5

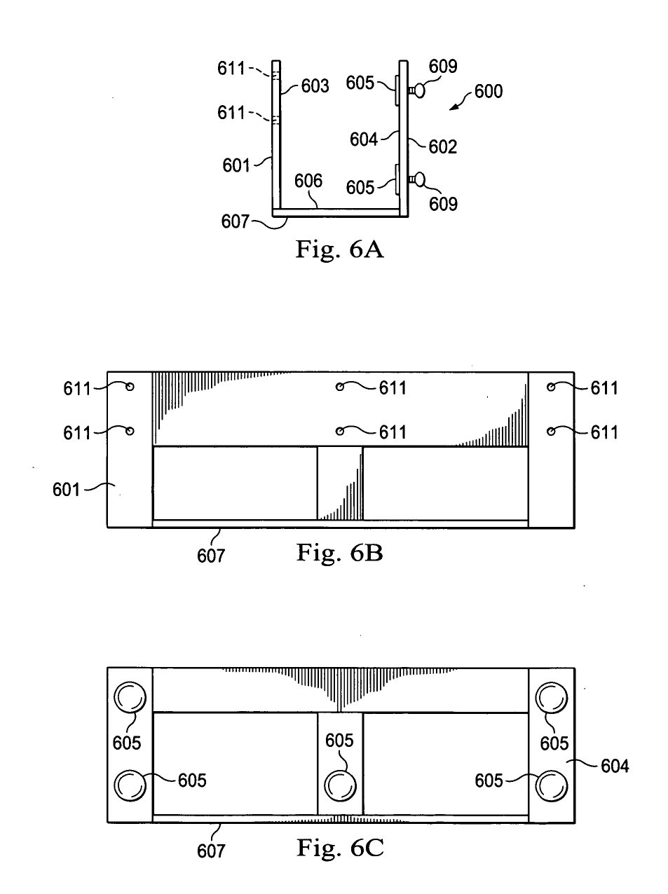

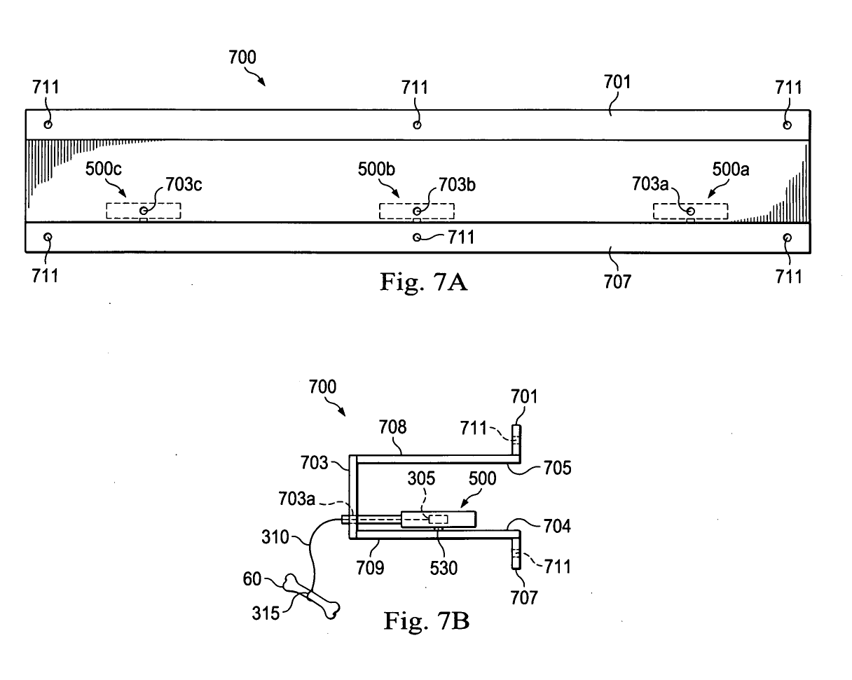

In FIGS. 6A-C, illustrated is a U-shaped bracket 600 provided as a base platform provided to fit under a door (not shown), and sandwiching the door, being held in place by suitable attachment means. As illustrated, the bracket 600 is inserted under an open door and engages the door adjacent surfaces 603, 604 and 606. A bottom surface 607 of the bracket is kept maximally clear of the floor by assuring that the interior surface of the bracket 606 is held in close proximity to the bottom edge of the door. Any remaining freedom of motion between the door and the bracket surfaces is removed by tightening the thumbscrew pads 605, also shown in FIG. 6C, with the corresponding jackscrews designated 609, located on the back surface 602 of the bracket 600. A surface 601, as illustrated in FIG. 6B, contains multiple screw holes 611 for mounting a non-rotatable version of the pet action device as illustrated in FIGS. 7A-7B, discussed below.

In FIGS. 7A and 7B, illustrated is yet another alternative version of the disclosed device that can be mounted on the door bracket of FIGS. 6A-6C. The device illustrated provides a platform and performs the same function as the device illustrated in FIGS. 1 and 2, but can be mounted on various forms of mounting brackets to stationary and moveable surfaces such as walls, posts columns and doors. The alternative version of the device may contain at least one retractable cord mechanism 500, attached to an attachment point 530, and comprising a cord 310, wherein a first end 305 of said cord 310 is attached to or about the fixation point 530 within a platform 700 and a second end 315 of said cord 310 can be extended through an opening 703a in a surface 703 of the platform 700, for example, and attached to a pet toy 60. The entire platform 700 is a C-shaped member which can be mounted to a variety of prefabricated mounting brackets utilizing screw means as demonstrated by the mounting holes 711 provided in flanges 701 and 707. Also, a plurality of retractable cord devices 500a-500c can be mounted on platform 700.

It should also be appreciated by one skilled in the art that although the retractable cord mechanism 500 and mounting point 530 are illustrated on a surface 704, it is understood that surface 705 could be used for the same purpose. Alternatively, if one was not concerned with providing maximum protection to the retractable cord device 500 and mounting point 530, surfaces 708 and 709 could be alternative mounting surfaces. Also, a plurality of openings such as 703a can be provided in the platform 700.

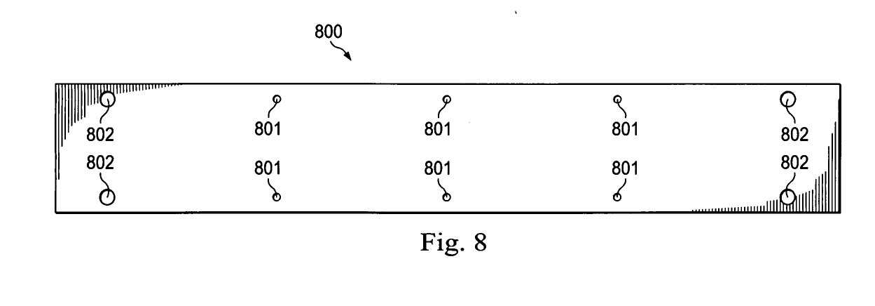

FIG. 8A illustrates another base for mounting the platform 700 illustrated in FIGS. 7A and 7B. FIG. 8 illustrates a plate 800, including screw holes 801 for attaching to the platform 700 and additional holes 802 for fastening plate 800 on a wall or other surface such as a fence or post.

### Example

An important advantage of the present disclosure is the ability to provide a restrained but captive pet toy, with a counter-resistive pulling force that is exerted on the toy in response to a dog pulling on the toy, simulating a tug-of-war, in the absence of direct human involvement. During testing of a prototype device, a young over-active Maltese puppy was utilized as a test subject. The puppy was known to be hyperactive, and required constant human attention to avert undesirable behaviors. When the pedestal mounted version of the device, with a hand-pumped vacuum mounted base, having a rotatable platform on a central spindle, was secured to a smooth, polished concrete floor, the puppy became suitably engaged in a tug-of-war with one of its favorite toys. The puppy was fully engaged by the counter-resistive pulling force that was exerted on the toy in response to a dog pulling on the toy. The puppy was able to constantly move around the device in an unrestricted 360° circular pattern, while engaging the device in a playful tug-of-war. When the puppy let go of the toy, the retractable cord device immediately pulled the toy back to the platform, causing the puppy to chase and reacquire the toy. The retractable cord device provided up to 10 lbs of resistance and the hand-pumped vacuum mounted based of the device provided a minimum of 40 lbs of resistive lift capacity, which was more than ample to restrict the young puppy from dislodging it from the floor after the vacuum was engaged.

An unanticipated, and desirable result of this non-human engagement with the device, was that the puppy remained interested and fully engaged in the simulated tug-of-war until substantial exhaustion occurred. It was noted that following a rest period, the puppy would easily reengage with the toys mounted on the device and repeat the cycle. It was also noted that prior to the introduction of the device, the puppy would rarely be engaged long enough, or to such a degree that it would ever appear to be tired. In fact, the hyperactive puppy was well known for its frequent barking and incessant need for human attention prior to its introduction to the device. Subsequently, the puppy's attention span was limited and behavior training was difficult. Following introduction to the device, the puppy appeared to be better rested, more attentive and better able to comprehend the desired behavior training required for most domesticated pets.

Although illustrative embodiments have been shown and described, a wide range of modification, change, and substitution is contemplated in the foregoing disclosure and in some instances, some features of the embodiments may be employed without a corresponding use of other features. Accordingly, it is appropriate that the claims be construed broadly and in a manner consistent with the scope of the embodiments disclosed herein.

What is claimed is:

1. A pet toy system comprising:
a base including means for securing the base to a support;
a platform attached to the base;
a retractable device attached to the platform and having a resiliently mounted tether forcibly extendable and automatically retractable relative to the platform; and
a pet toy attached to a terminal end of the tether adjacent the platform, whereby the toy can be forcibly extended away from and automatically retracted toward the platform.

2. The system of claim 1 wherein the platform is rotatably connected to the base and the retractable device is rotatably mounted on the platform.

3. The system of claim 1 wherein the base includes a suction attachment to the support.

4. The system of claim 1 wherein the base includes a threaded member extending into the support.

5. The system of claim 1 wherein the base is secured to a rigid surface by an attachment member.

6. The system of claim 1 wherein the base is a U-shaped channel member.

7. The system of claim 1 wherein the base is a rigid plate.

8. The system of claim 1 wherein the platform is a C-shaped member rigidly attached to the support.

9. A pet toy apparatus comprising:
a base including means for securing the base to a support;
a platform attached to the base;
a retractable device supported on the platform and including a tether having a terminal end adjacent a peripheral surface of the platform, the tether being resiliently forcibly extendable and automatically retractable relative to the peripheral surface; and
a pet toy attached to the terminal end of the tether and positioned at rest adjacent the peripheral surface, whereby the toy is moveable to be forcibly extended away from the peripheral surface and, upon release, automatically retracted toward and re-positioned adjacent the peripheral surface.

10. The apparatus of claim 9 wherein the platform is rotatably connected to the base.

11. The apparatus of claim 9 wherein the base includes a suction attachment to the support.

12. The apparatus of claim 9 wherein the base includes a threaded member extending into the support.

13. The apparatus of claim 9 wherein the base is secured to a rigid surface by an attachment member.

14. The apparatus of claim 9 wherein the base is a U-shaped channel member.

15. The apparatus of claim 9 wherein the base is a rigid plate.

16. The apparatus of claim 9 wherein the platform is a C-shaped member rigidly attached to the support.

17. The apparatus of claim 10 wherein the retractable device is rotatably mounted on the platform.
